(19) United States
(12) Patent Application Publication
(10) Pub. No.: US 2005/0266226 A1
(43) Pub. Date: Dec. 1, 2005

(54) Chemical mechanical polishing pad and method for selective metal and barrier polishing

(75) Inventor: Yaw S. Obeng, Orlando, FL (US)

Correspondence Address: HITT GAINES P.C., P.O. BOX 832570, RICHARDSON, TX, 75083, US

(73) Assignee: PsiloQuest, Orlando, FL (US)

(21) Appl. No.: 10/962,108

(22) Filed: Oct. 8, 2004

Related U.S. Application Data
(63) Continuation-in-part of application No. 10/641,866, filed on Aug. 15, 2003.
Application No. 10/641,866 is a continuation of application No. 10/241,074, filed on Sep. 11, 2002, now Pat. No. 6,706,383.
Application No. 10/241,074 is a continuation-in-part of application No. 09/994,407, filed on Nov. 27, 2001, now Pat. No. 6,579,604.
(63) Continuation-in-part of application No. 10/000,101, filed on Oct. 24, 2001, now Pat. No. 6,846,225.
(63) Continuation-in-part of application No. 10/727,058, filed on Dec. 3, 2003, now abandoned.
Application No. 10/727,058 is a division of application No. 10/241,985, filed on Sep. 12, 2002, now Pat. No. 6,684,704.
Application No. 10/241,985 is a continuation-in-part of application No. 10/000,101, filed on Oct. 24, 2001, now Pat. No. 6,846,225.
Application No. 10/241,985 is a continuation-in-part of application No. 10/241,074, filed on Sep. 11, 2002, now Pat. No. 6,706,383.
Application No. 10/241,985 is a continuation-in-part of application No. 09/998,471, filed on Nov. 29, 2001, now Pat. No. 6,596,388.
(60) Provisional application No. 60/250,299, filed on Nov. 29, 2000.
(60) Provisional application No. 60/295,315, filed on Jun. 1, 2001.
(60) Provisional application No. 60/304,375, filed on Jul. 10, 2001.
(60) Provisional application No. 60/250,299, filed on Nov. 29, 2000.
(60) Provisional application No. 60/295,315, filed on Jun. 1, 2001.
(60) Provisional application No. 60/304,375, filed on Jul. 10, 2001.

(51) Int. Cl. B32B 3/26; B32B 3/00

(52) U.S. Cl. 428/304.4; 428/314.4

(57) ABSTRACT

The present invention is directed, in general, to a polishing pad comprising a polishing body. The polishing body comprises a thermoplastic foam substrate having a surface comprising concave cells. The thermoplastic foam substrate comprises a blend of cross-linked ethylene vinyl acetate copolymer and polyethylene. The thermoplastic foam substrate has a hardness ranging from about 24 Shore A to about 100 Shore A. Other embodiments include a method for preparing the polishing pad, a polishing apparatus that includes the polishing pad, and a method of polishing a semiconductor substrate using the polishing pad.

### CROSS-REFERENCE TO RELATED APPLICATIONS

This application is a continuation-in-part of U.S. patent application Ser. No. 10/641,866, entitled “A POLISHING PAD SUPPORT THAT IMPROVES POLISHING PERFORMANCE AND LONGEVITY,” to Yaw S. Obeng and Peter Thomas, filed on Aug. 13, 2003, which in turn is a continuation of U.S. patent application Ser. No. 10/241,074, now U.S. Pat. No. 6,706,383, entitled, “A POLISHING PAD SUPPORT THAT IMPROVES POLISHING PERFORMANCE AND LONGEVITY,” to Yaw S. Obeng and Peter Thomas, filed on Sep. 11, 2002, which in turn, is a continuation-in-part of U.S. patent application Ser. No. 09/994,407, now U.S. Pat. No. 6,579,604, entitled, “A METHOD OF ALTERING AND PRESERVING THE SURFACE PROPERTIES OF A POLISHING PAD AND SPECIFIC APPLICATIONS THEREFOR,” to Yaw S. Obeng and Edward M. Yokley, filed on Nov. 27, 2001; a continuation-in-part of U.S. patent application Ser. No. 10/000,101, entitled, THE SELECTIVE CHEMICAL-MECHANICAL POLISHING PROPERTIES OF A CROSS LINKED POLYMER AND SPECIFIC APPLICATIONS THEREFOR, to Yaw S. Obeng and Edward M. Yokley, filed on Oct. 24, 2001; and a continuation-in-part of U.S. patent application Ser. No. 10/727,058, entitled MEASURING THE SURFACE PROPERTIES OF POLISHING PAD USING ULTRASONIC REFLECTANCE, to Yaw S. Obeng, filed on Dec. 3, 2003, which, in turn, is a divisional patent application of U.S. patent application Ser. No. 10/241,985, now U.S. Pat. No. 6,684,704, entitled, MEASURING THE SURFACE PROPERTIES OF POLISHING PAD USING ULTRASONIC REFLECTANCE, to Yaw S. Obeng, filed on Sep. 12, 2002, which, in turn, is a continuation-in-part of the above-mentioned U.S. patent application Ser. Nos. 10/000,101 and 10/241,074, as well as, U.S. patent application Ser. No. 09/998,471, now U.S. Pat. No. 6,596,388, entitled, “A METHOD OF INTRODUCING ORGANIC AND INORGANIC GRAFTED COMPOUNDS THROUGHOUT A THERMOPLASTIC POLISHING PAD USING A SUPERCRITICAL FLUID AND APPLICATIONS THEREFOR,” to Edward M. Yokley and Yaw S. Obeng, filed on Nov. 29, 2001; both of U.S. patent application Ser. Nos. 09/994,407 and 10/000,101, in turn, claim the benefit of U.S. Provisional Application 60/250,299 entitled “SUBSTRATE POLISHING DEVICE AND METHOD,” to Edward M. Yokley, filed on Nov. 29, 2000; U.S. Provisional Application 60/295,315 entitled, “A METHOD OF ALTERING PROPERTIES OF A POLISHING PAD AND SPECIFIC APPLICATIONS THEREFOR,” to Yaw S. Obeng and Edward M. Yokley, filed on Jun. 1, 2001; and U.S. Provisional Application 60/304,375 entitled, “A METHOD OF ALTERING PROPERTIES OF A THERMOPLASTIC FOAM POLISHING PAD AND SPECIFIC APPLICATIONS THEREFOR,” to Yaw S. Obeng and Edward M. Yokley, filed on Jul. 10, 2001; all which are commonly assigned with the present invention and incorporated herein by reference as if reproduced herein in its entirety.

### TECHNICAL FIELD OF THE INVENTION

The present invention is directed to the manufacture and use of chemical mechanical polishing pads for creating a smooth, ultra-flat surface on such items as glass, semiconductors, dielectrics, metals, barrier layers and composites thereof, magnetic mass storage media and integrated circuits.

### BACKGROUND OF THE INVENTION

Chemical mechanical polishing (CMP) has been successfully used for planarizing metal, barrier and dielectric films. In one plausible mechanism of planarizing, the polishing process involves intimate contact with high points on the wafer surface and the pad material, in the presence of slurry. In this scenario, corroded materials, produced from reactions between the slurry and wafer surface being polished, are removed by shearing at the pad-wafer interface. The elastic properties of pad material significantly influence the final planarity and polishing rate. In turn, the elastic properties are a function of both the intrinsic polymer and its foamed structure.

Historically, polyurethane-based pads have been used for CMP because of their high strength, hardness, modulus and high elongation at break. While such pads can achieve both good uniformity and efficient topography reduction, their ability to rapidly and uniformly remove surface materials drops off rapidly as a function of use. The decline in material removal rates as a function of time observed for polyurethane-based pads has been attributed to changes in the mechanical response of such polishing pads under conditions of critical shear. Polyurethane pads also generally require a break-in period before polishing, in addition to reconditioning and pretreatment after a period of use. It is often also necessary to keep such traditional pads wet while polishing equipment is in idle mode. All of these characteristics undesirably reduce the overall efficiency of CMP when using polyurethane or similar conventional pads.

It is generally believed that the loss in functionality of polyurethane-based CMP pads is due to pad decomposition from the interaction between the pad and the slurries used in the polishing. In some instances, the surface modification of materials used for CMP polishing pads may improve the application performance. Such modifications, however, are only temporary and require frequent replacement or pretreatment of the CMP pad, resulting in higher device fabrication costs.

Polyurethane pad decomposition is exacerbated by the move towards the use of low K porous dielectric materials in integrated circuits. To avoid damaging or delaminating these soft dielectric materials during polishing, it is desirable to use gentler mechanical forces (e.g., lower down-force and less abrasive slurries) and more aggressive slurry chemistries. However, polyurethane pads are more prone to decomposition in acidic and peroxide-containing slurries, as compared to conventional slurries.

Decomposition of the polyurethane pads produces a surface modification in and of itself which can be detrimental to uniform polishing. For instance, organic residues, such as aromatic diisocyanates, aliphatic and aromatic diamines and aliphatic polyethers and polyesters, produced from the decomposition of the polyurethane pad, can stain the metal surface of a wafer during polishing. These organic residues, in turn, can cause the electromigration lifetime of the metal to shorten, resulting in shorter device lifetimes. Organic residue stains on the surface also increase the number of surface defects found during metrology post-polishing inspection of wafers. These surface defects can be transferred into underlying levels of metal, barrier or insulating levels on the wafer, thereby resulting lower yields of serviceable wafers.

Barrier removal presents another challenge to conventional CMP processes and materials. It is increasingly desirable to minimize copper and dielectric loss during barrier removal. As such low ratios of copper and dielectric removal to barrier removal are highly desirable.

Accordingly, what is needed is an improved longevity CMP pad capable of providing a highly planar low-defect surface during CMP with good selectivity towards metal or barrier removal, while not experiencing the above-mentioned problems.

### SUMMARY OF THE INVENTION

To address the above-discussed deficiencies of the prior art, the present invention provides in one embodiment, a polishing pad comprising a polishing body comprising a thermoplastic foam substrate. The thermoplastic foam substrate has a surface comprising concave cells. The thermoplastic foam substrate comprises a blend of cross-linked ethylene vinyl acetate copolymer and polyethylene. The thermoplastic foam substrate has a hardness ranging from about 24 Shore A to about 100 Shore A.

Another embodiment of the present invention is directed to a method for preparing a polishing pad. The method includes providing a polishing body comprising a thermoplastic foam substrate as described above and exposing cells within the thermoplastic foam substrate to form a surface comprising concave cells.

Still another embodiment is a polishing apparatus. The polishing apparatus includes a mechanically driven carrier head, a polishing platen, a polishing pad attached to the polishing platen. The carrier head is positionable against the polishing platen to impart a polishing force against the polishing platen. The polishing pad includes a polishing body comprising a thermoplastic foam substrate as described above.

Yet another embodiment is a method of polishing a semiconductor substrate. The method includes providing a semiconductor substrate having a barrier layer over the semiconductor substrate and a metal layer over the barrier layer. The method further includes polishing the metal layer using a polishing pad, wherein the polishing pad includes a polishing body comprising a thermoplastic foam substrate as described above. The method further includes polishing the barrier layer using the polishing pad.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the scope of the invention.

### BRIEF DESCRIPTION OF THE DRAWINGS

For a more complete understanding of the present invention, reference is now made to the following descriptions taken in conjunction with the accompanying drawings, in which:

FIG. 1 presents an exemplary polishing pad of the present invention;

FIG. 2 illustrates, by flow diagram, a method for preparing a polishing pad of the present invention;

FIG. 3 illustrates a polishing apparatus, including a polishing pad fabricated using a thermoplastic foam polymer made according to the principles of the present invention;

FIG. 4 illustrates, by flow diagram, a method of polishing a semiconductor substrate according to the principles of the present invention;

FIG. 5 presents exemplary data to compare the removal rates of a bulk copper layer (BULK), a dielectric layer (PETEOS) and a tantalum barrier layer (BARR) using polishing pads of the present invention and conventional pads;

FIG. 6 presents representative data showing the relationship between within-wafer-non-uniformity (WIWNU) in the removal rate of a barrier layer using polishing pads of the present invention as a function of slurry flow rate and polishing down force;

FIG. 7 presents representative data showing the relationship between barrier layer and bulk copper layer removal rates (BARR:BULK) using polishing pads of the present invention as a function of slurry flow rate and polishing down force; and

FIG. 8 presents exemplary data comparing the total indicated run-out (TIR) for test wafers after bulk and seed copper layer and barrier layer polishing stages, using polishing pads of the present invention and conventional pads; and

FIG. 9 presents additional exemplary data comparing the total indicated run-out (TIR) for test wafers after bulk and seed copper layer and barrier layer polishing stages, using polishing pads of the present invention and conventional pads.

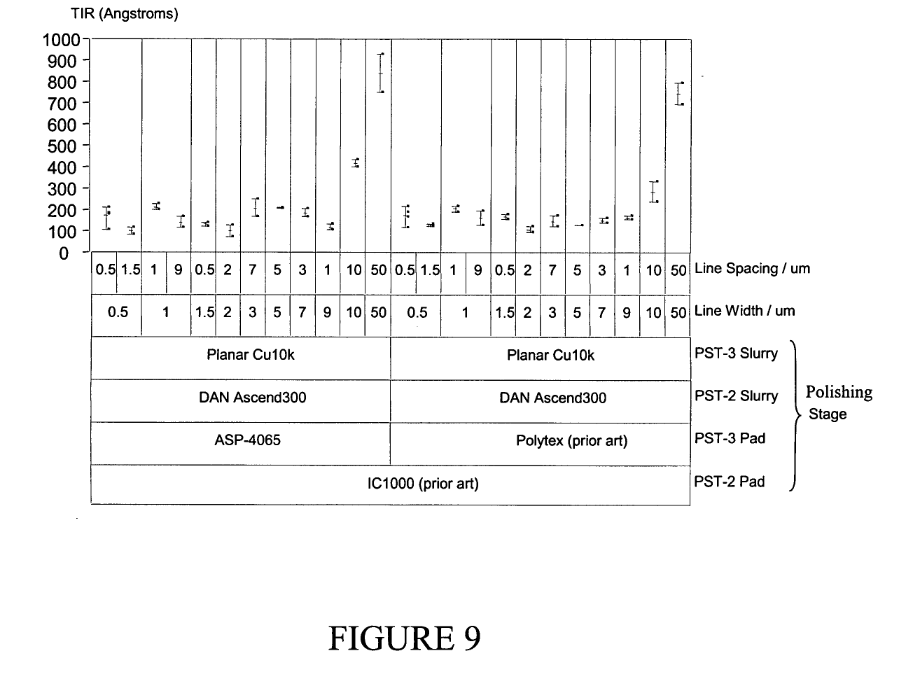

### DETAILED DESCRIPTION

The present invention benefits from the realization of two guiding principles. The first guiding principle is that more uniform polishing is obtained when the hardness of the polishing pad is tailored to the hardness of the surface being polished. That is, preferably, a soft polishing pad is used to polish a soft semiconductor substrate surface, while a hard polishing pad is used to polish a hard semiconductor substrate surface. The polishing pads of the present inventions are advantageous because their hardness can be adjusted by altering the composition of a thermoplastic foam substrate of the pad, as well as adjusting the size of the cells in the thermoplastic foam substrate.

A second guiding principle is that contaminants released from conventional polishing pads in the presence of aggressive CMP slurries can substantially contribute to the number of defects on the surface of polished wafers. In particular, the decomposition products of polyurethane-containing polishing pads can contaminant the wafer surface being polished, thereby introducing defects into the polished surface. The thermoplastic foam substrate-containing, and polyurethane-free, polishing pads of the present inventions are advantageous because they are less prone to decomposition and the release of defect-causing contaminants in the presence of aggressive CMP slurries.

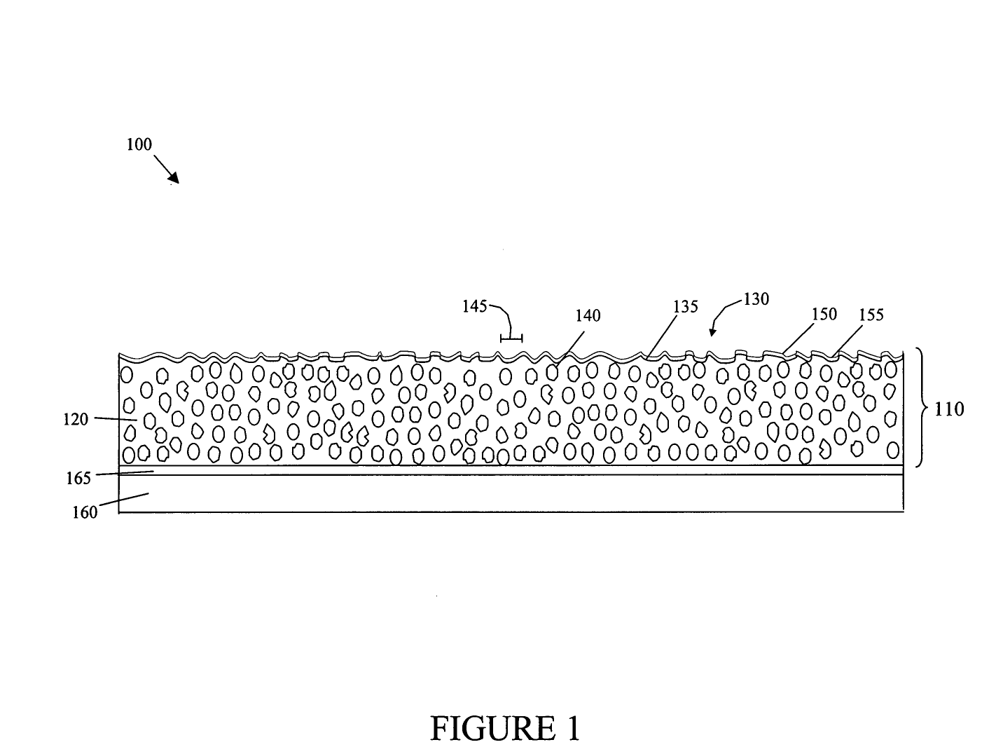

One embodiment of the present invention is a polishing pad. FIG. 1 presents an exemplary polishing pad 100 of the present invention. The polishing body 110 includes a thermoplastic foam substrate 120, the thermoplastic foam substrate 120 having a surface 130 comprising concave cells 135. In some preferred embodiments, the concave cells 135 at the surface 130 of the substrate 120 are substantially the same as the size of cells 140 throughout the substrate 120.

It is desirable for the thermoplastic foam substrate 120 to comprise a closed-cell foam of cross-linked copolymers. The term cell 140 as used herein, refers to any volume defined by a membrane within the substrate 120 occupied by air, or other gases used as blowing agents. Substantially concave cells 135 are formed from cells 140 upon exposing the substrate 120 as discussed below. The concave cells 135 or cells 140 need not have smooth or curved walls. Rather, the concave cells 135 or cells 140 can have irregular shapes and sizes. As further explained below, the composition of the thermoplastic foam substrate 120, and the procedure used to prepare the thermoplastic foam substrate 120, affect the shape and size of the concave cells 135 or cells 140.

The thermoplastic foam substrate 120 comprises a blend of cross-linked ethylene vinyl acetate (EVA) copolymer and polyethylene (PE). In some preferred embodiments, the EVA copolymer comprises about 15 to about 20 wt %, and more preferably, about 18% vinyl acetate, balance ethylene. In some cases, the EVA copolymer and polyethylene are cross-linked with each other.

Preferably the polyethylene is a low-density or medium-density polymer. For the purposed of the present invention, a low-density polyethylene copolymer is defined as a density ranging from about 0.1 to about 0.3 gm/cc, while a medium-density polyethylene copolymer is defined as having a density ranging from about 0.4 to about 0.97 gm/cc. Some embodiments of the thermoplastic foam substrate 120 have a density ranging from about 8 to about 25 lb/ft³ (˜0.13 to ˜0.4 g/cc), and some preferred embodiments, density ranges from about 15 to about 20 lb/ft³ (˜0.25 to ˜0.32 g/cc).

Non-limiting examples of closed-cell foams of cross-linked copolymers comprising EVA and polyethylene include: Volara™ and Volextra™ (from Voltek Corp.); Senflex EVA™ (from Rogers Corp.); J-foam™ (from JMS Plastics JMS Plastics Supply, Inc.); and VS Foam 5555 and VS Foam 5565 (from Vulcan Corp., Clarksville Term).

In some advantageous embodiments, the blend has an ethylene vinyl acetate:polyethylene weight ratio ranging from about 1:9 to about 9:1. In some preferred embodiments, the blend has an ethylene vinyl acetate:polyethylene weight ratio ranging from about 0.6:9.4 to about 1.8:8.2. In other preferred embodiments, the blend has an ethylene vinyl acetate:polyethylene weight ratio ranging from about 0.6:9.4 to about 1.2:8.8.

In certain preferred embodiments, the blend comprises EVA ranging from about 5 to about 45 wt %, and preferably about 6 to about 25 wt %. In some advantageous embodiments where a harder polishing body 110 is desired, the blend comprises from about 12 to about 24 wt % EVA, and in other cases from about 5 to about 11 wt %. Blends have such low percentages of EVA are also conducive to the desirable production of concave cells 135 having a smaller size, as further discussed below.

The thermoplastic foam substrate 120 has a hardness ranging from about 24 Shore A to about 100 Shore A. Certain blends or EVA and PE are selected to provide a substrate 120 with a particular hardness which in turn, is conducive to the polishing of particular types of materials of specific hardness. For example, it is preferable to polish a metal layer of tungsten with a thermoplastic foam substrate 120 having a hardness ranging from about 24 Shore A to about 55 Shore A, and more preferably about 24 Shore A to about 34 Shore A. As another example, it is preferable to polish a metal layer of copper with a thermoplastic foam substrate 120 having a hardness ranging from about 34 Shore A to about 64 Shore A, and more preferably about 55 Shore A to about 64 Shore A. Still another example is polishing a barrier layer of tantalum or tantalum nitride with a thermoplastic foam substrate 120 having a hardness ranging from about 55 Shore A to about 100 Shore A. Of course, to tune the relative rates of polishing of individual or multiple layers of different metal layers, or metal layers and barrier layers, thermoplastic substrates 120 with different hardness values or ranges and can be used than that recited above.

The composition of the thermoplastic foam substrate 120 can be changed to adjust its hardness so as to more effectively polish different metals or barrier layer materials with specific hardness values. As noted above, for instance, preferred embodiments of the polishing body 110 can have a thermoplastic foam substrate 120 with a hardness ranging from about 24 Shore A to about 35 Shore A. In such embodiments, the thermoplastic foam substrate 120 preferably comprises a blend of ethylene vinyl acetate:polyethylene having a weight ratio ranging from about 10:1 to about 8:1, and more preferably, about 9:1. Other preferred embodiments of the polishing body 110 have a thermoplastic foam substrate 120 with a hardness ranging from about 55 Shore A to about 65 Shore A. In such embodiments, the thermoplastic foam substrate 120 preferably comprises a blend of ethylene vinyl acetate:polyethylene having a weight ratio ranging from about 6:4 to about 4:6, and more preferably about 5:5. Still other embodiments of the polishing body 110 have a thermoplastic foam substrate 120 with a hardness ranging from about 65 Shore A to about 100 Shore A, and more preferably about 65 Shore A to about 80 Shore A. Such embodiments preferably comprise a blend of ethylene vinyl acetate:polyethylene having a weight ratio of about 5:5 or lower.

In certain embodiments, the thermoplastic foam substrate 120 has cells 140 formed throughout the substrate 120. In certain preferred embodiments, the cells 140 are substantially spheroidal. In other preferred embodiments, the size of the cells are such that, on skiving the substrate, cells 140 of the substrate 120 have an average size 145 ranging from about 5 microns to about 600 microns. In some cases, the average size 145 ranges from about 100 to about 350 microns, preferably about 100 to about 250 microns and more preferably about 115 to about 200 microns. In other cases, for instances, where a harder polishing surface is desired, the concave cells 130 have an average size ranging from about 5 to about 100 microns. In some cases the cells 130 have an average size 145 ranging from about 1 microns to about 25 microns, while in other cases the average size ranges from about 5 microns to about 25 microns. Cell size 145 can be determined using standardized protocols, developed and published by the American Society for Testing and Materials (West Conshohocken, Pa.), such as ASTM D3576, incorporated herein by reference.

In certain preferred embodiments, where the shape of the cell 140 is substantially spherical, cell size 145 is approximately equal to the mean cell diameter. Cell size 145 can be adjusted by adjusting the content of EVA copolymer, for example, such as disclosed by Perez et al. J. Appl. Polymer Sci., vol. 68, 1998 pp 1237-1244, incorporated by reference herein. As disclosed by Perez et al. bulk density and cell density are inversely related. Thus, in certain preferred embodiments, the density of concave cells 140 at the surface of the substrate 120 ranges from 2.5 to about 100 cells/mm², and more preferably, ranges about 60 to about 100 cells/mm². Cell density can be determined from visual inspection of microscopic images of the substrate's surface 130, or other conventional procedures well known to those skilled in the art.

Some advantageous embodiments of the thermoplastic foam substrate 120 have at least about 85 wt % Xylene insoluble material. The process for measuring Xylene insoluble materials is well known to those of ordinary skill in the art. Such processes can involve, for example, digestion of the blend in Xylene for 24 hours at 120° C. followed by drying and comparing the weight of the residual insoluble material to the predigestion material.

The thermoplastic foam substrate 120 can comprise up to about 25 wt %, and in some cases, up to about 50 wt % of an inorganic filler material. The inorganic filler can comprise any Group I, Group II or Transition Metal well known to those of ordinary skill in the art to impart desirable translucence, color or lubricant properties to the foam substrate 120. For example, the inorganic filler can be selected from the group consisting of talc, titanium oxides, calcium silicates, calcium carbonate, magnesium silicates, and zinc salts. The thermoplastic foam substrate 120, in certain preferred embodiments, comprises about 17 wt % talc. In other embodiments, the filler comprises silica (about 15 to about 30 wt %, and more preferably about 20 to about 25 wt %), zinc oxides (about 1 wt %), stearic acid (about 1 wt %), and other additives and pigments (up to about 2%) well known to those of ordinary skill in the art. Other conventional filler materials, such as that revealed in U.S. Pat. Nos. 6,425,816 and 6,425,803, incorporated by reference herein, are also within the scope of the present invention.

Some desirable embodiments of the thermoplastic foam substrate 120 have mechanical properties that facilitate polishing. In some instance, for example, it is preferable for the thermoplastic foam substrate 120 to be capable of deforming during polishing to an extent sufficient to allow the interior surface of the concave cells 130 to facilitate polishing. In certain embodiments, for example, the thermoplastic foam substrate 120 has a Tensile Elongation ranging from about 100% to about 800%. In certain preferred embodiments, Tensile Elongation ranges from about 100% to about 450%. In yet other embodiments, Tensile Elongation ranges from about 600% to about 800%. Tensile Elongation can be determined using standard protocols, such as ASTM D3575, incorporated herein by reference.

Although the polishing pad 100 can be used as described above for polishing, optionally in some cases, an interior surface 155 of the concave cells 135 is coated with a polishing agent 150. The interior surface 155 of the concave cells 135 form excellent receptacles for receiving a uniform coating of the polishing agent 150. Though not limiting the scope of the present invention by theory, it is hypothesized that the center of the concave cell 135 serves as an excellent nucleating point for coating because the surface energy of the cell 135 at the center is lowest. It is believed that the initiation of coating at this location facilitates the uniform coverage of the interior surface of the concave cell 135 with the polishing agent 150, thereby facilitating the polishing performance of a pad 100 having such a surface.

The polishing agent 150 can comprise one or more ceramic compounds, or one or more organic polymers, resulting from the grafting of the secondary reactants on the substrate's surface 130, as disclosed in the above-cited U.S. patent application Ser. No. 09/994,407. The polishing agent 150 can be an oxide, silicate or nitride of a transition metal. For instance, the ceramic polishing agents 150 can comprise an inorganic metal oxide resulting when an oxygen-containing organometallic compound is used as the secondary reactant to produce a grafted surface. The secondary plasma mixture can include a transition metal such as titanium, manganese, or tantalum. However, any metal element capable of forming a volatile organometallic compound, such as metal ester contain one or more oxygen atoms, and capable of being grafted to the surface 130 is suitable. Silicon may also be employed as the metal portion of the organometallic secondary plasma mixture. In these embodiments, the organic portion of the organometallic reagent can be an ester, acetate, or alkoxy fragment. In some preferred embodiments, the polishing agent 150 can be silicon oxides and titanium oxides, tetraethoxy silane polymer; and titanium alkoxide polymer. Non-limiting examples include: SiO2, Ta₂O₅, TiO₂, Al₂O₃, ZrO, HfO₂, ZrSiₓO_{y} (where x is from ˜0.1 and ˜30, and y is ˜0.1 and ˜30), HfSiₓO_{y} (where x is from ˜0.1 and ˜30, and y is ˜0.1 and ˜30), or a mixture thereof. In other instances, the polishing agent 150 is derived from a metalorganic precursor, such as tetraethylorthosilicate (TEOS), tetraisopropoxy titanium (IV), zirconium(IV) t-butoxide (ZTB) or a mixture thereof.

Numerous secondary reactants can be used to produce the ceramic polishing agent 150. The secondary plasma reactant can be ozone, alkoxy silanes, water, ammonia, alcohols, mineral sprits or hydrogen peroxide, for example. In some preferred embodiments, the secondary plasma reactant is composed of titanium esters, tantalum alkoxides, including tantalum alkoxides wherein the alkoxide portion has 1-5 carbon atoms; manganese acetate solution in water; manganese alkoxide dissolved in mineral spirits; manganese acetate; manganese acetylacetonate; aluminum alkoxides; alkoxy aluminates; aluminum oxides; zirconium alkoxides, wherein the alkoxide has 1-5 carbon atoms; alkoxy zirconates; magnesium acetate; and magnesium acetylacetonate. Other embodiments are also contemplated for the secondary plasma reactant, for example, alkoxy silanes and ozone, alkoxy silanes and ammonia, titanium esters and water, titanium esters and alcohols, or titanium esters and ozone.

Alternatively, where organic compounds are used as the secondary plasma reactant, the polishing agent 150 can comprise an organic polymer. Examples of such secondary reactants include: allyl alcohols; allyl amines; allyl alkylamines, where the alkyl groups contain 1-8 carbon atoms; allyl ethers; secondary amines, where the alkyl groups contain 1-8 carbon; alkyl hydrazines, where the alkyl groups contain 1-8 carbon atoms; acrylic acid; methacrylic acid; acrylic acid esters containing 1-8 carbon atoms; methacrylic esters containing 1-8 carbon atoms; or vinyl pyridine, and vinyl esters, for example, vinyl acetate. In certain preferred embodiments, the polishing agent 150 is selected from a group of polymers consisting of polyalcohols and polyamines.

In some embodiments, the polishing pad 100 further includes an optional backing material 160 coupled to the polishing body 110, using for example, a conventional adhesive 165. In some instances, a stiff backing material 160 limits the compressibility and elongation of the foam 120 during polishing, which in turn, reduces erosion and dishing effects during metal polishing via CMP. In certain preferred embodiments, the stiff backing material 160 comprises a high-density polyethylene (i.e., greater than about 0.98 gm/cc), and more preferably, a condensed high-density polyethylene. Of course, other high-density polymers can be used as the backing material 160.

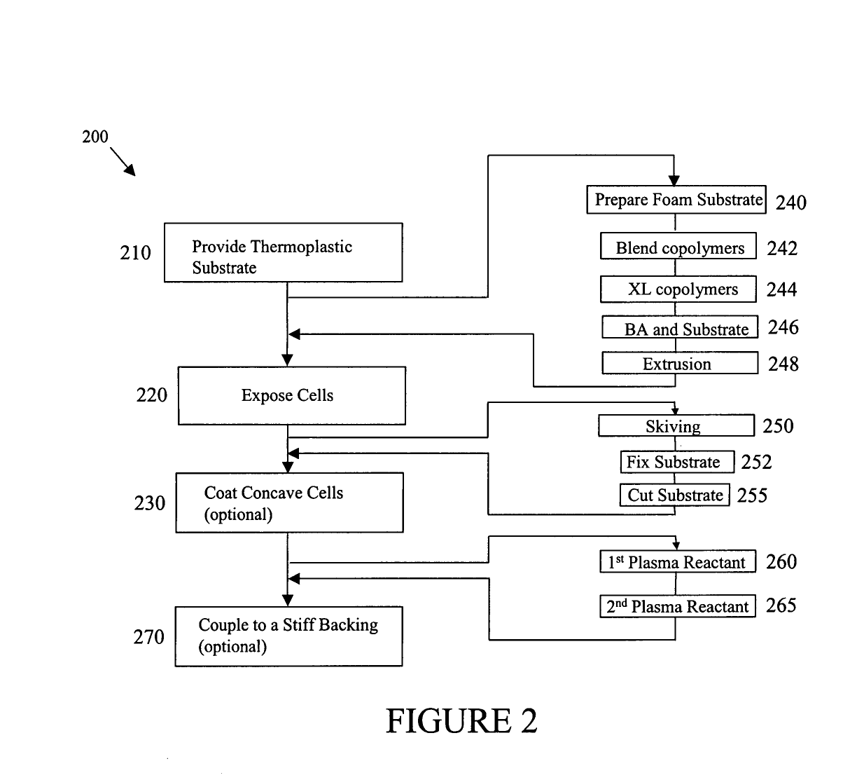

Yet another embodiment of the present invention is a method for preparing a polishing pad. Turning to the flow diagram depicted in FIG. 2, the method 200 comprises providing a thermoplastic foam substrate in step 210, and exposing cells within the substrate to form a surface comprising concave cells in step 220. The method can optionally include a step 230 of coating an interior surface of the concave cells with a polishing agent.

Providing a polishing body in step 210 comprises any of the embodiments of the thermoplastic foam substrate described herein. Certain preferred embodiments of the method for preparing the polishing pad also include a foaming process step 240 to prepared a closed-cell thermoplastic foam substrate. The size of the cells in the thermoplastic substrate affects the size of the concave cells ultimately formed on its surface. Several factors can be adjusted to change the size of the closed cells. As noted above the relative amounts of ethylene vinyl acetate copolymer and polyethylene can be controlled to advantageously adjust the hardness of the substrate, as well as the size of cells produced during the foaming process 240. In addition, the kind of foaming process 240 used can produce different cell sizes. Any foaming process 240 well known to those of ordinary skill in the art can be used. The foaming process 240 can include, blending in step 242, of the polymers comprising the substrate in a conventional blending device. The foaming process 240 can also include a step 244 of cross-linking the EVA and PE polymers of the thermoplastic foam substrate, using irradiation or chemical means to achieve cross-linking. The foaming process 240 can still further include a step 246 of forming a mixture of the substrate and a blowing agent, preferably under pressure, and extruding the mixture in step 248 through a conventional die to form sheets of closed-cell foams. Of course, other conventional techniques well known to those of ordinary skill in the art can be use to prepare closed-cell or open-celled foams.

Any conventional procedures can be used in step 220 to expose cells within the thermoplastic foam substrate to form a surface comprising concave cells. The surface of concave cells can be formed by skiving or other conventional techniques, in step 250, the thermoplastic foam substrate. The term skiving as used herein means any process to a cut away a thin layer of the surface of the substrate so as to expose concave cells within the substrate. Skiving can be achieved using any conventional technique and device well known to one of ordinary skill in the art. For example, exposing cells can be achieved by fixing the thermoplastic foam substrate on a planar surface in step 252, and cutting, in step 255, a thin layer (i.e., ranging from about 1200 microns to about 2000 microns) from the surface of the substrate.

In some optional embodiments, the interior surface of the concave cells is coated with a polishing agent in step 230. Coating the interior surface the concave cells can be achieved using the grafting procedure disclosed in the above-cited U.S. application Ser. No. 09/994,407. In certain embodiments, coating can comprise exposing the interior surface to an initial plasma reactant to produce a modified surface thereon in step 260. Coating can also comprise exposing the modified surface to a secondary plasma reactant to create a grafted surface on the modified surface in step 265, the grafted surface comprising the polishing agent. Any of the primary and secondary reactants or procedures described above or in U.S. patent application Ser. No. 09/994,407 can be used in the grafting process to coat the polishing agent on the interior surface of the concave cells of the substrate of the present invention.

In other optional embodiments, the method for preparing the polishing pad includes coupling 270 the thermoplastic foam substrate to a stiff backing material, such as those backing materials described above. In certain embodiments, coupling 270 is achieved via chemical bonding using a conventional adhesive, such as epoxy or other materials well known to those skilled in the art. In other preferred embodiments, coupling 270 is achieved via extrusion coating of the molten backing material onto the foam. In still other embodiments, the backing is thermally welded to the thermoplastic foam substrate to achieve coupling 270.

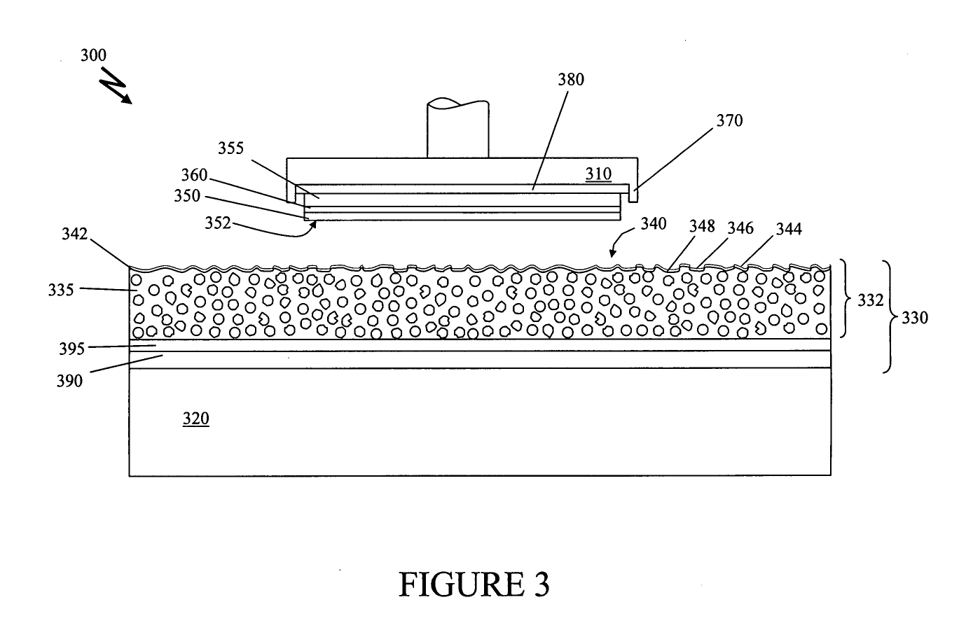

Yet another embodiment of the present invention is a polishing apparatus. As illustrated in FIG. 3, the apparatus 300 comprises a mechanically driven carrier head 310, a polishing platen 320, the carrier head 310 being positionable against the polishing platen 320 to impart a polishing force against the polishing platen 320. The apparatus 300 further includes a polishing pad 330 attached to the polishing platen 320. The polishing pad 330 comprises a polishing body 332 that includes a thermoplastic foam substrate 335 having a surface 340 comprising concave cells 344. The polishing body 330 can optionally include a polishing agent 346 coating the interior surface 348 of the concave cells 344. Any of the thermoplastic foam substrates and methods of preparation described above can be used to form the polishing pad 330. Similarly, the thermoplastic foam substrate can further include any of the above-described embodiments of a surface comprises concave cells 344 and the optional polishing agent 346 coating an interior surface 348 of the concave cells.

In certain preferred embodiments, the polishing pad 330 of the polishing apparatus 300 is configured to polish a metal layer 350, such as a copper or tungsten layer, on a surface 352 of a device substrate 355, such as a semiconductor wafer, at a removal rate of at least about 500 Angstroms/minute, and more preferably at least about 2000 Angstroms/minute. Moreover such polishing rates can be sustained for the polishing of a plurality of polishing operations using the same polishing pad 330. For example, when the metal layer 350 is substantially a copper or tungsten layer, such removal rates can be attained and sustained for the polishing of at least 500 and more preferably at least 1000 wafers. In other preferred embodiments, the removal rate of the metal layer 350 during polishing of a device substrate surface 352 remains within about ±20%.

In other preferred embodiments, the polishing pad 330 of the polishing apparatus 300 is configured to polish the metal layer 350 to yield a surface 352 with a low density of defects. One of ordinary skill in the art would be familiar with the use of conventional light scattering measurements and devices to quantify the number of light point defects counts per wafer. In particular, preferred embodiments of the apparatus 300, the surface 352, after polishing the metal layer 350 of copper or tungsten, has a defect density corresponding to less than about 300 counts/200 mm wafer, and more preferable less than about 50 counts/200 mm wafer.

It is advantageous for the polishing pad of the polishing apparatus 300 to be capable of polishing both a metal layer 350, such as a copper seed layer, and a barrier layer 360, such as tantalum, titanium, tantalum nitride or titanium nitride. In certain preferred embodiments, the polishing pad 330 is capable of successively polishing a metal layer 350 and a barrier layer 360 on the semiconductor substrate 355 at a ratio of removal rates of the barrier layer 360 to the metal layer 350 ranging from about 1:1 to about 5:1. In certain preferred embodiments, the semiconductor substrate surface 352, after polishing the barrier layer 360, has a defect density corresponding to less than about 200 and more preferably less than about 50 counts/200 mm wafer. Moreover, such results can be obtained in aggressive slurry environments. Examples of some aggressive slurries include a pH of less than about 7, and more preferably ranges from about 6 to about 5, greater than about 2 and more preferably greater than about 3 percent hydrogen peroxide (H₂O₂), or combinations thereof.

Additional optional embodiments of the apparatus 300 may include a conventional carrier ring 370 and adhesive 380 to securely couple the semiconductor substrate 355 to the carrier head 310. The polishing body 330 can further include an optional backing material 390 coupled to the thermoplastic foam substrate 335, for example, using a conventional adhesive 395 or by thermal welding.

Yet another embodiment of the present invention is a method 400 for polishing a semiconductor substrate. The method of polishing includes a step 410 of providing a semiconductor substrate, such as a silicon wafer. The semiconductor substrate includes a barrier layer over, and in some cases on, the semiconductor substrate, and a metal layer over, and in some cases on, the barrier layer. In some preferred embodiments, the metal layer is a copper seed layer having a thickness of about 100 nanometers, and the barrier layer is a tantalum or tantalum nitride layer having a thickness of about 25 nanometers. Of course, any conventional semiconductor substrate having one or more metal and barriers layers, such as interlevel metal layers used to interconnect active devices, can be polished by the method of the present invention.

The polishing method also includes a step 420 of polishing the metal layer using a polishing pad having a polishing body comprising a thermoplastic foam substrate. Any of the above-described embodiments of the polishing pad can be used in the method 400. Preferred polishing conditions include using a down force ranging from about 3 to about 5 psi, and slurry flow rate ranging from about 100 to 150 ml/minute. Other polishing conditions can include a table speed ranging from about 20 to 100 rpm and a carrier speed ranging from about 20 to about 110 rpm.

The polishing method also includes a step 430 of polishing the barrier layer using the same polishing pad as used to polish the metal layer in step 430. In some cases, the polishing conditions and polishing pad for barrier layer polishing are chosen to achieve greater selectivity for barrier removal over metal removal. In some preferred embodiments the polishing pad, in cooperation with the first and second slurry, is capable of polishing the metal layer and the barrier layer at a ratio of removal rates of the barrier layer to the metal layer ranging from about 1:1 to about 5:1. Of course in other cases, the metal layer and barrier layer are polished using the same slurry.

The polishing method of the present invention can be incorporated into a conventional three-step polishing process, such described in the Example section below, and other processes well known to those of ordinary skill in the art. In one three-step polishing process, in step 460, a bulk metal layer, such as a bulk copper layer on a seed metal layer, is polished. In some instances, the bulk metal layer is polished in step 460 using the polishing pad of the present invention. In other cases polishing in step 460 is done using a conventional polishing pad. Then, the metal layer and barrier layer are successively polished in steps 420 and 430, respectively, as described above.

Having described the present invention, it is believed that the same will become even more apparent by reference to the following experiments. It will be appreciated that the experiments are presented solely for the purpose of illustration and should not be construed as limiting the invention. For example, although the experiments described below may be carried out in a laboratory setting, one skilled in the art could adjust specific numbers, dimensions and quantities to appropriate values for a full-scale plant setting.

### EXAMPLES

Experiments were conducted to characterize the polishing properties of polishing pads in the present invention and to compare their polishing properties to conventional polyurethane-based pads.

Example of Pad Manufacture

The polishing pads of the present invention have a polishing body laminated to a backing material comprising an about 0.03 inch thick condensed HDPE layer (hardness about 90 shore A). Coupling between the polishing body and the backing material was achieved via extrusion coating of the molten HDPE on a prefabricated roll of thermoplastic foam. To affix the polishing pad to a polishing table, the backing material was backed with a pressure sensitive adhesive (3M product number 9731).

The polishing body comprised one of various thermoplastic foam substrates comprising an EVA-PE closed cell foams (such as VS Foam 5555 and VS Foam 5565, Vulcan Corp., Clarksville Tenn.). The thermoplastic foam substrate was skived with a commercial cutting blade (Model number D5100 K1, from Fecken-Kirfel, Aachen, Germany) and then manually cleaned with an aqueous/isopropyl alcohol solution. After skiving, the polishing body was about 64 mils thick and had a surface comprising concave cells.

A polishing agent comprising an about 500 micron thick layer of amorphous SiO₂ or TiO₂ was coated on to an interior surface of the concave cells. The polishing agent-coated polishing body was then laser scored to afford slurry channels. Polishing agent coating was achieved via plasma enhanced CVD. To coat the substrate with polishing agent, comprising silicon dioxide, the skived substrate was placed in the reaction chamber of a conventional commercial Radio Frequency Glow Discharge plasma reactor having a temperature controlled electrode configuration (Model PE-2; Advanced Energy Systems, Medford, N.Y.). The plasma treatment of the substrate was commenced by introducing the primary plasma reactant, Argon, for about 30 to about 120 seconds, depending on sample size and rotation speed, within the reaction chamber maintained at about 350 mTorr. The electrode temperature was maintained at about 30° C., and a RF operating power of about 100 to about 2500 Watts was used, depending on the sample and reaction chamber size.

Subsequently, the secondary reactant was introduced for either 10 or 30 minutes at 0.10 SLM and consisted of the silicon dioxide metal ester precursor, TEOS, mixed with He or Ar gas. The amount of precursor in the gas stream was governed by the vapor pressure of the secondary reactant monomer at the monomer reservoir temperature (typically, 90±10° C.). Similar procedures were used to prepare polishing bodies coated with a polishing agent comprising TiO₂, using a secondary plasma reactant containing tetraisopropoxytitinate (IV).

Several types of polishing pads of the present invention were prepared and tested as described below. A pad, designated ASP-4055, was prepared using an EVA-PE closed cell foam having a hardness of about 55 Shore A. Another pad, designated ASP-4065, was prepared using an EVA-PE closed cell foam having a hardness of about 65 Shore A. Both the ASP-4055 and ASP-4065 pads had a polishing agent comprising TiO₂. Still another pad, designated ASP-4135, was prepared using an EVA-PE closed cell foam having a hardness of about 35 Shore A and a polishing agent comprising SiO₂.

### Polishing Example 1

Polishing properties were assessed using a commercial polisher, the IPEC 472 (Ebara Technologies, Sacramento, Calif., now owned by Novellus Systems Inc., CA). No preconditioning was performed on the pad prior to commencing the experiment. Unless otherwise noted, the removal rate of copper polishing was assessed using a down force of about 20 kPa (˜3 psi), back side pressure of about 6.9 kPa (˜1 psi) a table speed of about 25 rpm, a carrier speed of about 40 rpm and slurry flow rate of about 125 ml/min.

Test silicon wafers were used to evaluate the polishing properties of the pads of the present invention and various commercial pads. The test wafers had a layer plasma-enhanced deposit of oxides from TEOS (PETEOS), a layer of tantalum (BARR) on the TEOS layer, and a bulk copper layer (BULK) on a copper seed layer.

The polishing properties of the polishing pads were examined using a variety of commercial slurries. The slurry, Cu10K-2, was used as provided by the manufacturer (Planar Solutions, Adrian, Mich.). The iCue®5001 and iCue®5003 slurries were mixed with a ˜30% stock solution of hydrogen peroxide to provide a slurry concentration of 2-3% hydrogen peroxide, in a ratio of slurry to hydrogen peroxide of about 93:7. The slurries Cu600Y and iCue®5220, were used as provided by the manufacturer (Cabot Microelectronics, Aurora, Ill.). The slurry Ascend™ Cu300 (Dupont AirProducts NanoMaterials, LLC, Carlbad, Calif.) was mixed with ˜30% stock hydrogen peroxide to provide a slurry concentration of 2-3% hydrogen peroxide, in a ratio of slurry to hydrogen peroxide of about about 93:7 to about 90:10.

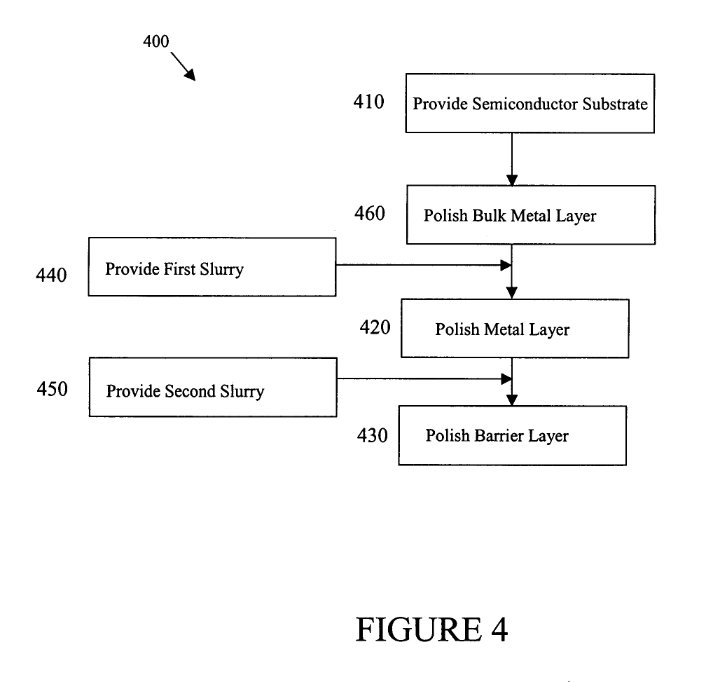

FIG. 4 presents exemplary polishing results for a plurality of test wafers, using polishing pads of the present invention (designated Pad A: SiO₂ polishing agent and hardness of 65 Shore A) and polyurethane-based pads (IC1000/SUBA IV pad stack and Politex pads, all from Rodel, Newark Del.). These results illustrate that the ASP-4065 polishing pad provide removal rates of BARR and PETEOS that are substantially similar to that obtained using the commercial IC1000/SUBA IV pad stack. The removal rate of BULK using the ASP-4065 polishing pad is about 50% lower than the removal rate using the IC1000/SUBA IV pad stack.

Similar findings were obtained when polishing performance using the ASP-4065 is compared to polishing performance using the IC1000/SUBA IV pad stack and to Politex pads, using the slurries listed in FIG. 4, as well as other slurries. The ASP-4065 and politex pads have substantially the same removal rates of BULK using the Cu10K-2 slurry. The removal rates of BULK using the ASP-4065 pad was about 50% of the removal rate using the IC1000/SUBA IV pad stack using the Ascend 300:2-3% H₂O₂ slurry. The ASP-4065 pad and Politex pads have similar removal rates of BARR and PETEOS using the Cu10K-2 slurry. These results illustrate the potential for pads of the present invention, such as the ASP-4065 pad, to be used for end-stage copper polishing as well as barrier polishing.

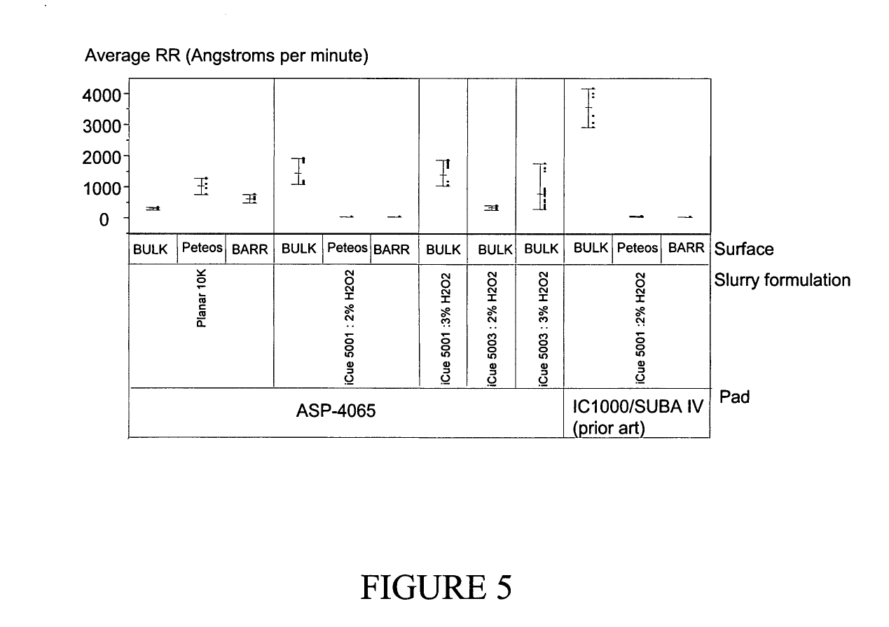

Within-wafer-nonuniformity (WIWNU) of polishing across a wafer surface was assessed using the same polishing apparatus and under similar polishing conditions as described above. Contour plots of the surfaces after polishing were measured electrically by measuring sheet resistance at 49 points distributed radially across the wafer. The average post-polishing depths of material removed across individual wafers was calculated as a within-wafer-removal-rate (WIWRR) and the percent standard deviation (% std) of the depth removed (WIWNU) was calculated from the 49 measured of sheet resistance. As illustrated in FIG. 5 (Cu10K-2 slurry), the WIWNU of BARR polishing is dependent on the polishing down force and slurry flow rate.

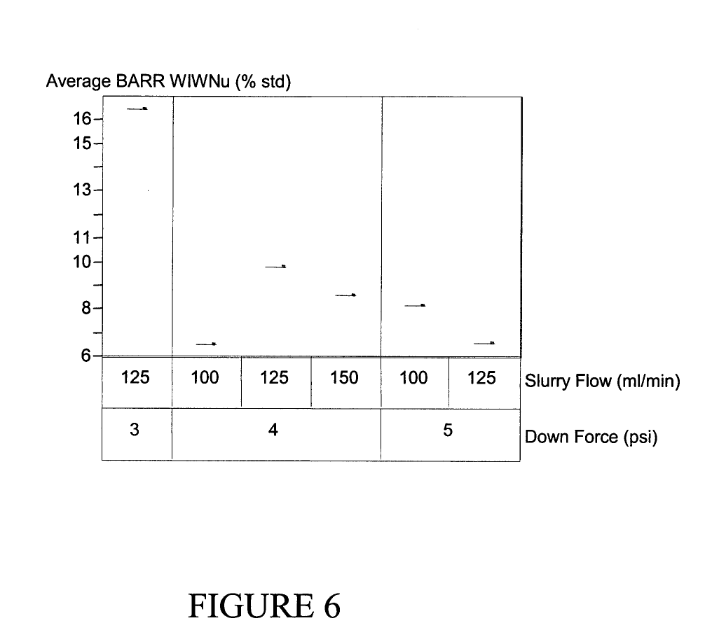

The selectivity of polishing for BARR relative to BULK is also dependent on down force and slurry flow rate. For instance, as illustrated in FIG. 6, the ratio of relative removal rates of BARR versus BULK (Cu10K-2 slurry, BARR=tantalum) can vary from −2.1:1 to ˜1.8:1 as the slurry flow is increased from 100 to 150 ml/min. Alternatively, this ratio can increase from ˜1.8:1 to ˜2.1:1 as the down force is increased from 3 to 5 psi.

### Polishing Example 2

Further experiments were done to assess the uniformity of removal of copper, barrier and dielectric using test wafers having a surface with copper lines of varying widths (or sizes) and spacing (SKW 6-3 test wafer, SKW Associates Inc., Santa Clara Calif.). The SKW 6-3 test wafers had a ˜0.55 micron thick layer PETEOS, a ˜25 nanometer thick BARR layer on the PETEOS layer, a ˜100 nanometer thick copper seed layer (SEED) on the BARR layer, a ˜1 to ˜1.5 micron thick BULK layer on the SEED layer. The polishing conditions simulated the components of a three-step polishing process as further described below.

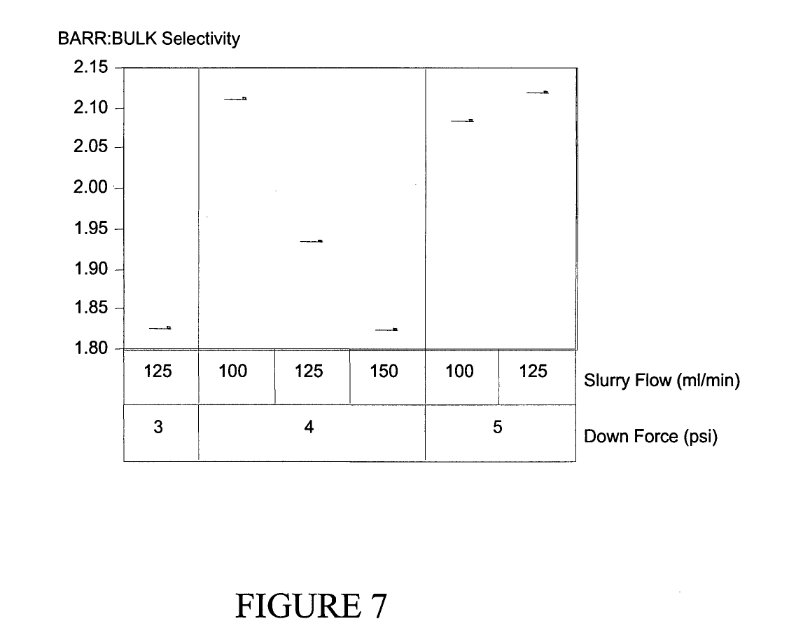

The local uniformity (e.g., dishing, erosion, and oxide loss) of the removal rate was quantified by determining the total indicated run-out (TIR), the difference in height from the highest and lowest point on the wafer. FIG. 7 presents exemplary TIR data for SKW 6-3 test wafers before polishing (In-Coming) and after three stages of polishing. TIR data was obtained using 1150 micron scans on P2. The BULK is polished in a first polishing stage (PST-1) with the IC1000/SUBA IV pad stack (IC1000) using a Cu600Y slurry. BULK polishing was continued for a sufficient period to substantially remove the BULK layer, thereby exposing the SEED layer. Polishing of the SEED layer was then performed using either the ASP 4065 pad or IC1000/SUBA IV pad stack and iCue 5001 slurry in a second polishing stage (PST-2). SEED polishing was continued for a sufficient period to substantially remove the SEED layer, thereby exposing the BARR layer. The BARR layer and underlying PETEOS layer were then polished in a third polishing stage (PST-3), using either the ASP 4065 pad, IC1000/SUBA IV pad stack or a Polytex pad, and Cu10K-2 slurry.

FIG. 7 further illustrates that the portion of the test wafer surface having large line size (e.g., from about 10 to about 100 micron widths) is less uniform than the portion of the surface having small line sizes (e.g., than about 10 microns wide). FIG. 7 also illustrates that the ASP-4065 pad can be used to achieve planarization that is substantially the same as that obtained using the IC1000/SUBA IV pad stack in stage two polishing. Moreover, ASP-4065 pad can be used to achieve planarization that is substantially the same as that obtained using the Politex pad in stage three polishing. Thus, the same ASP-4065 pad can be used in both stage two SEED removal and stage three BARR removal, thereby replacing the use of two different conventional pads normally used at these respective stages of polishing.

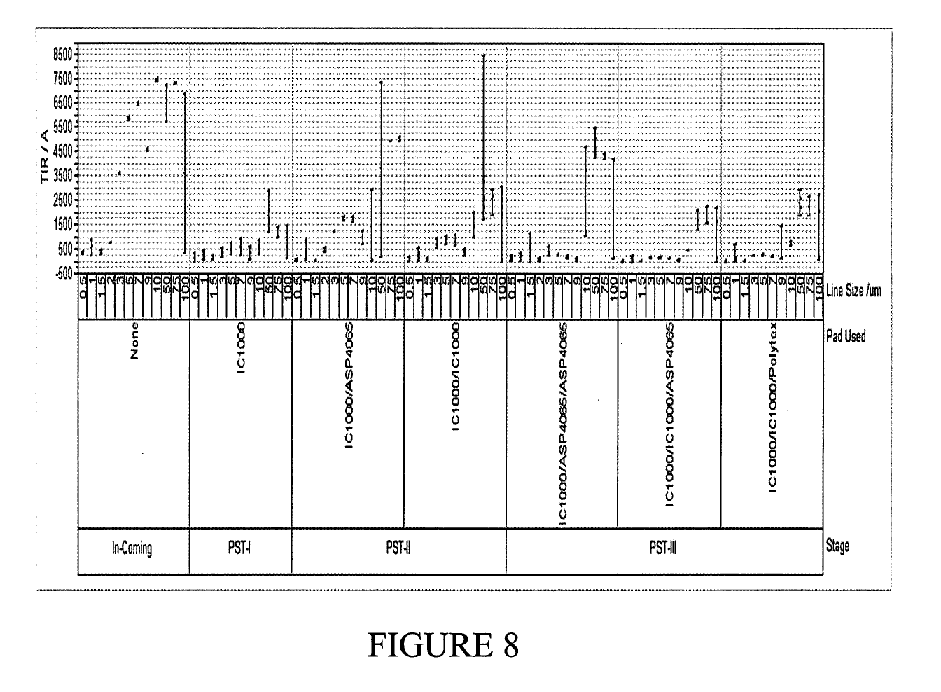

FIG. 8 presents additional exemplary TIR data for SKW 6-3 test wafers after three stages of polishing. TIR data was obtained using 500 micron scans on P2. The BULK of wafer was polished in stage one substantially the same as described for FIG. 7 using an IC1000/SUBA IV pad stack and Cu600Y slurry. In stage two, all wafers were polished using the IC1000/SUBA IV pad stack and Ascend™ Cu300 slurry. Then in stage three, the wafers were polished using either a ASP-4065 pad polytex pad, and Cu10K-2 slurry. The ASP-4065 pad achieved substantially the same degree of planarization of wafer as wafers polished with the Polytex pad.

### Polishing Example 3

Additional experiments were done to quantify the amount of surface defects in copper layered wafers polished using the ASP-4135 pads of the present invention, as compared to a conventional polishing pad (IC1010, from Rodel, Newark Del.) The copper surface of 50 wafers was polished using a slurry comprising C600Y plus H₂O₃ (˜3% vol) and removal rate of about 5000 Angstroms/min. Surface defects were measured using a Surfscan SP1 DLS with data collected in oblique angle mode 0.24-5.0 μm (KLA-Tencor, San Jose, Calif.). The average defect count for 10 to 50 wafers polished using the ASP-4135 pad ranged from about 132 counts/200 mm wafer to about 93 counts/200 mm wafer. In comparison, the average defect count for wafers polished using an IC1010 pad under similar polishing conditions ranged from about 360 counts/200 mm wafer to about 735 counts/200 mm wafer. Similar defect counts were obtained using the ASP-4055 or ASP-4065 pads when polishing both copper seed and tantalum barrier layers on a patterned test wafer under conditions similar to stage 3 polishing, as described in Example 2 above.

Although the present invention has been described in detail, those skilled in the art should understand that they can make various changes, substitutions and alterations herein without departing from the scope of the invention.

1. A polishing pad comprising:
a polishing body comprising a thermoplastic foam substrate having a surface comprised of concave cells, wherein said thermoplastic foam substrate comprises a blend of cross-linked ethylene vinyl acetate copolymer and polyethylene, said thermoplastic foam substrate having a hardness ranging from about 24 Shore A to about 100 Shore A.

2. The polishing pad as recited in claim 1, wherein an interior of said thermoplastic foam substrate comprises a closed-cell foam.

3. The polishing pad as recited in claim 1, wherein said blend has an ethylene vinyl acetate copolymer:polyethylene ratio ranging from about 0.6:9.4 to about 9:1.

4. The polishing pad as recited in claim 1, wherein said blend has an ethylene vinyl acetate copolymer:polyethylene ratio ranging from about 8:1 to about 10:1.

5. The polishing pad as recited in claim 1, wherein said blend has an ethylene vinyl acetate copolymer:polyethylene ratio ranging from about 4:6 to about 6:4.

6. The polishing pad as recited in claim 1, wherein said blend has an ethylene vinyl acetate copolymer:polyethylene ratio of less than about 5:5.

7. The polishing pad as recited in claim 1, wherein said thermoplastic foam substrate has a hardness ranging from about 24 Shore A to about 34 Shore A.

8. The polishing pad as recited in claim 1, wherein said thermoplastic foam substrate has a hardness ranging from about 34 Shore A to about 55 Shore A.

9. The polishing pad as recited in claim 1, wherein said thermoplastic foam substrate has a hardness ranging from about 55 Shore A to about 65 Shore A.

10. The polishing pad as recited in claim 1, wherein said concave cells have an average size ranging from about 1 microns to about 25 microns.

11. The polishing pad as recited in claim 1, wherein said polyethylene is a low-density polyethylene.

12. The polishing pad as recited in claim 8, wherein said polyethylene is a medium-density polyethylene.

13. The polishing pad as recited in claim 8, wherein said ethylene vinyl acetate copolymer comprises from about 15 to about 20 wt % acetate.

14. A method for preparing a polishing pad comprising:
providing a polishing body comprising a thermoplastic foam substrate, where said thermoplastic foam substrate comprises a blend of cross-linked ethylene vinyl acetate copolymer and polyethylene, said thermoplastic foam substrate having a hardness ranging from about 24 Shore A to about 100 Shore A; and
exposing cells within said thermoplastic foam substrate to form a surface comprising concave cells.

15. The method as recited in claim 14, wherein said blend has an ethylene vinyl acetate copolymer:polyethylene ratio ranging from about 0.6:9.4 to about 9:1.

16. A polishing apparatus comprising:
a mechanically driven carrier head;
a polishing platen, said carrier head being positionable against said polishing platen to impart a polishing force against said polishing platen; and
a polishing pad attached to said polishing platen, said polishing pad including:
a polishing body comprising a thermoplastic foam substrate having a surface comprised of concave cells, wherein said thermoplastic foam substrate comprises a blend of cross-linked ethylene vinyl acetate copolymer and polyethylene, said thermoplastic foam substrate having a hardness ranging from about 24 Shore A to about 100 Shore A.

17. The polishing apparatus as recited in claim 16, wherein said polishing pad is capable of successively polishing a metal layer and a barrier layer on a semiconductor substrate at a ratio of removal rates of said barrier layer to said metal layer ranging from about 1:1 to about 5:1.

18. The polishing apparatus as recited in claim 17, wherein said barrier layer is selected from the group consisting of: tantalum, titanium, tantalum nitride and titanium nitride, and said metal layer comprises copper or tungsten.

19. A method for polishing a semiconductor wafer comprising:
providing a semiconductor substrate having a barrier layer over said semiconductor substrate and a metal layer over said barrier layer;
polishing said metal layer using a polishing pad,
wherein said polishing pad includes a polishing body comprising a thermoplastic foam substrate having a surface comprised of concave cells, wherein said thermoplastic foam substrate comprises a blend of cross-linked ethylene vinyl acetate copolymer and polyethylene copolymer, said thermoplastic foam substrate having a hardness ranging from about 24 Shore A to about 100 Shore A; and
polishing said barrier layer using said polishing pad.

20. The method as recited in claim 19, wherein said polishing pad in cooperation with said first and second slurry is capable of polishing said metal layer and said barrier layer at a ratio of removal rates of said barrier layer to said metal layer ranging from about 1:1 to about 5:1.
